(19) United States
(12) Patent Application Publication
(10) Pub. No.: US 2015/0234580 A1
(43) Pub. Date: Aug. 20, 2015

(54) DRIVER INTERFACE FOR A VEHICLE COMBINATION METER

(71) Applicant: Toyota Motor Engineering & Manufacturing North America, Inc., Erlanger, KY (US)

(72) Inventors: Nathaniel J. Secord, Toledo, OH (US); Aaron J. Brendible, Ypsilanti, MI (US)

(73) Assignee: Toyota Motor Engineering & Manufacturing North America, Inc., Erlanger, KY (US)

(21) Appl. No.: 14/180,609

(22) Filed: Feb. 14, 2014

(51) Int. Cl. G06F 3/0484; G06F 3/0482; G01C 9/06; G06F 3/0481; B60C 23/02; B60K 35/00

(52) U.S. Cl. CPC G06F 3/04847; B60C 23/02; B60K 35/00; G01C 9/06; G06F 3/04817; G06F 3/0482; B60K 2350/1024; B60K 2350/1072; G01C 2009/066; B60T 2230/03

(57) ABSTRACT

A computing device and methods for operating a driver interface for a vehicle combination meter are disclosed. One example method includes receiving, from a driver, an indication of an icon selection. The icon can represent the vehicle combination meter. The method further includes sending, for display in the driver interface and in response to the indication selecting the icon for the vehicle combination meter, vehicle status information associated with a first vehicle system. The first vehicle system can be associated with off-road operation of a vehicle. The method further includes receiving, from the driver, an indication requesting navigation within the driver interface to additional vehicle status information and sending, for display in the driver interface and in response to the indication requesting navigation within the driver interface, vehicle status information associated with a second vehicle system. The second vehicle system can be associated with off-road operation of the vehicle.

### BACKGROUND

A vehicle combination meter can provide information to a driver or passenger of a vehicle about the status of various vehicle systems during vehicle operation. For example, a vehicle combination meter can display information regarding the current speed of the vehicle, the radio station currently playing within the vehicle, the pressure of each vehicle tire, etc., within one display or over separate pages or tabs that serve as subsets of the display. However, there are no vehicle combination meters allowing a driver to easily monitor a comprehensive set of vehicle systems pertinent to off-road operation and towing performance within the same driver interface.

### SUMMARY

Various driver display interfaces for a vehicle combination meter are described herein. The display interfaces can be grouped together such that a driver or passenger can obtain vehicle status information related to various vehicle systems associated with off-road vehicle operation, vehicle towing operation, or both, using straightforward means of navigation between the types of vehicle status information. In addition, the vehicle status information can be displayed to the driver within different areas of the display interface for the vehicle combination meter. Using different areas of the display interfaces also allows flexibility in terms of displaying more than one type of vehicle status at a time to the driver, further aiding in off-road or towing operation of the vehicle.

In one implementation, a computer-implemented method of displaying a driver interface for a vehicle combination meter is disclosed. The method includes receiving, from a driver, an indication of an icon selection, the icon representing the vehicle combination meter; sending, for display in the driver interface and in response to the indication selecting the icon for the vehicle combination meter, vehicle status information associated with a first vehicle system, the first vehicle system associated with off-road operation of a vehicle; receiving, from the driver, an indication requesting navigation within the driver interface to additional vehicle status information; and sending, for display in the driver interface and in response to the indication requesting navigation within the driver interface, vehicle status information associated with a second vehicle system, the second vehicle system associated with off-road operation of the vehicle.

In another implementation, a computing device is disclosed. The computing device includes one or more processors for controlling the operations of the computing device and a memory for storing data and program instructions used by the one or more processors. The one or more processors are configured to execute instructions stored in the memory to: receive, from a driver, an indication of an icon selection, the icon representing a vehicle combination meter; send, for display in a driver interface and in response to the indication selecting the icon for the vehicle combination meter, vehicle status information associated with a first vehicle system, the first vehicle system associated with off-road operation of a vehicle; receive, from the driver, an indication requesting navigation within the driver interface to additional vehicle status information; and send, for display in the driver interface and in response to the indication requesting navigation within the driver interface, vehicle status information associated with a second vehicle system, the second vehicle system associated with off-road operation of the vehicle.

### BRIEF DESCRIPTION OF THE DRAWINGS

The description herein makes reference to the accompanying drawings wherein like reference numerals refer to like parts throughout the several views, and wherein:

FIG. 1 is a block diagram of a computing device for implementing a driver interface for a vehicle combination meter;

FIGS. 2A-2B are example driver interfaces for the vehicle combination meter displaying vehicle status information associated with a first vehicle system as implemented using the computing device of FIG. 1;

FIGS. 3A-3B are example driver interfaces for the vehicle combination meter displaying vehicle status information associated with a second vehicle system as implemented using the computing device of FIG. 1;

FIGS. 4A-4B are example driver interfaces for the vehicle combination meter displaying vehicle status information associated with a third vehicle system as implemented using the computing device of FIG. 1;

FIGS. 5A-5B are example driver interfaces for the vehicle combination meter displaying vehicle status information associated with a fourth vehicle system as implemented using the computing device of FIG. 1;

FIGS. 6A-6B are example driver interfaces for the vehicle combination meter displaying vehicle status information associated with a fifth vehicle system as implemented using the computing device of FIG. 1; and

FIG. 7 is an example driver interface for the vehicle combination meter displaying vehicle status information associated with the first vehicle system and the second vehicle system as implemented using the computing device of FIG. 1.

### DETAILED DESCRIPTION

This disclosure describes various driver interfaces for a vehicle combination meter and methods and devices for implementing the driver interfaces. In one method of implementing a driver interface, the a driver can select an icon representing the vehicle combination meter and a computing device associated with the vehicle can send vehicle status information associated with a first vehicle system for display within the driver interface. The first vehicle system can be associated, for example, with off-road operation of a vehicle. The driver can also send a request to navigate to additional vehicle status information, and the computing device can send vehicle status information associated with a second vehicle system for display within the driver interface. The second vehicle system can also be associated with off-road operation of the vehicle. Additional navigation is also possible in order to display vehicle status information associated with third, fourth, and fifth vehicle systems, these vehicle systems being associated with off-road operation or towing operation of a vehicle.

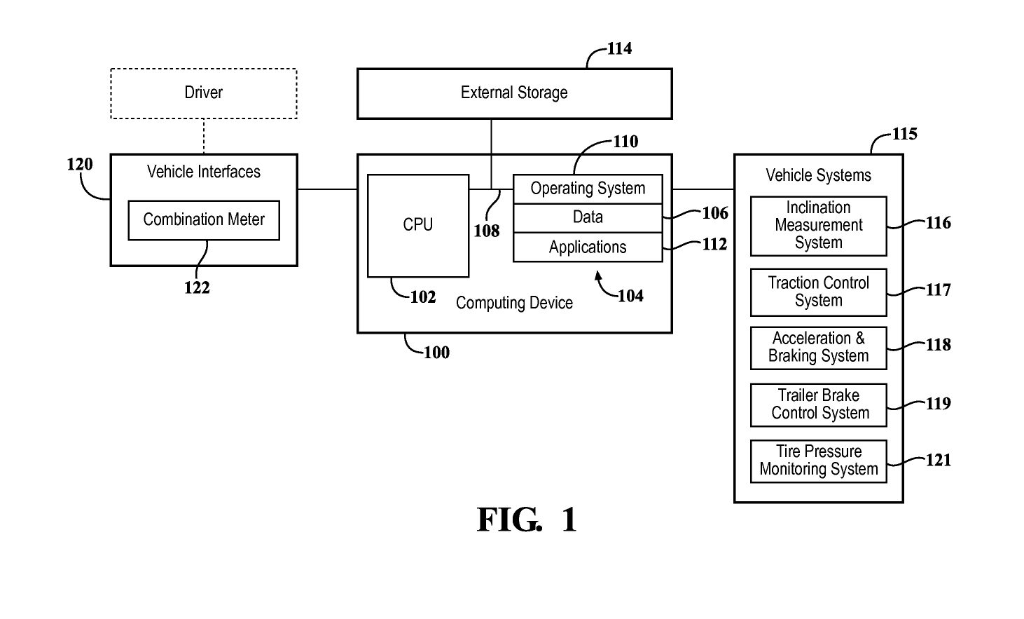

FIG. 1 is a block diagram of a computing device 100 for implementing a driver interface for a vehicle combination meter. The computing device 100 can be any type of vehicle-installed, handheld, desktop, or other form of single computing device, or can be composed of multiple computing devices. The processing unit in the computing device can be a conventional central processing unit (CPU) 102 or any other type of device, or multiple devices, capable of manipulating or processing information. The memory 104 in the computing device can be a random access memory device (RAM) or any other suitable type of storage device. The memory can include data 106 that is accessed by the CPU using a bus 108.

The memory 104 can also include an operating system 110 and installed applications 112, the installed applications 112 including programs that permit the CPU 102 to implement the driver interface for the vehicle combination meter as described below. The computing device 100 can also include secondary, additional, or external storage 114, for example, a memory card, flash drive, or any other form of computer readable medium. In one embodiment, the installed applications 112 can be stored in whole or in part in the external storage 114 and loaded into the memory 104 as needed for processing.

The computing device 100 can also be coupled to one or more vehicle systems 115. The vehicle systems 115 can, for example, include an inclination measurement system 116, a traction control system 117, an acceleration and braking system 118, a trailer brake control system 119, and a tire pressure monitoring system 121, all relevant for off-road operation or towing operation of the vehicle and described in additional detail below. The computing device 100 can also be coupled to one or more vehicle interfaces 120 configured to receive inputs from the driver and provide feedback to the driver of the vehicle. The vehicle interfaces 120 can include, for example, a combination meter 122. The combination meter 122 can be configured to allow the driver to navigate between various display screens or pages in order to view the status of the various vehicle systems 115 as further described below.

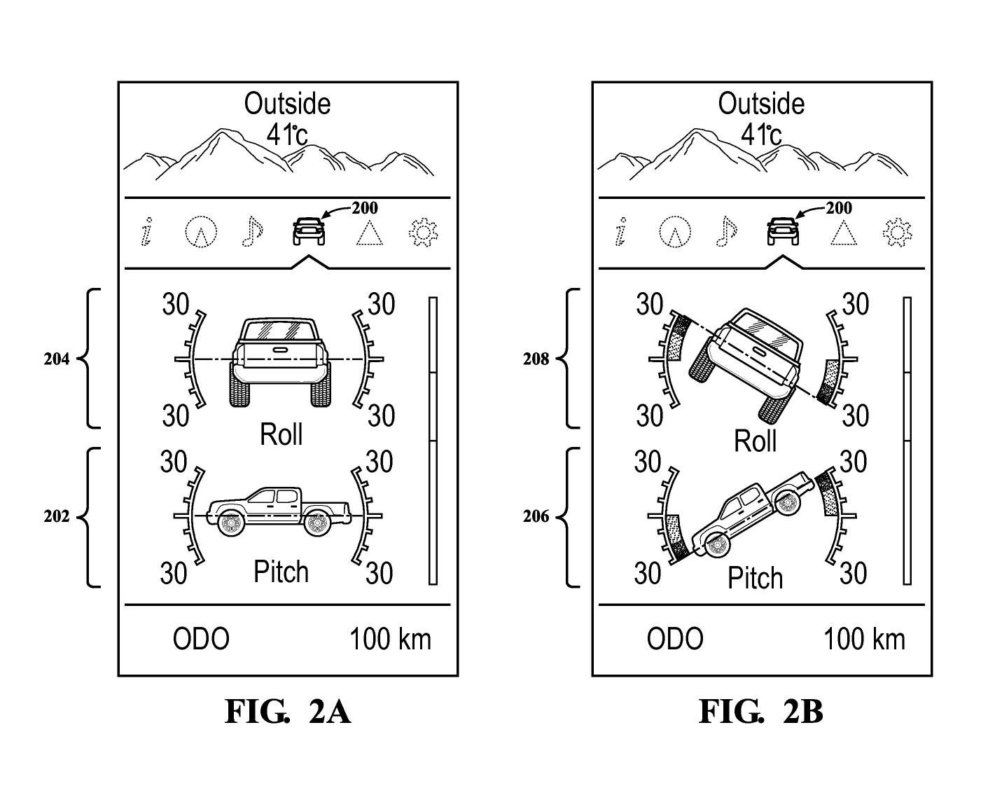

FIGS. 2A-2B are example driver interfaces for the vehicle combination meter displaying vehicle status information associated with a first vehicle system as implemented using the computing device 100 of FIG. 1. The first vehicle system represented within the example driver interfaces of FIGS. 2A-2B is the inclination measurement system 116 mentioned in association with FIG. 1. Two types of vehicle status information, vehicle pitch and vehicle roll, can be displayed to the driver once the computing device 100 receives an indication that the driver has selected an icon associated with the vehicle combination meter. In this example, the vehicle combination meter icon 200 appears in the form of the front view of a truck and is displayed within a vehicle interface in proximity to a plurality of other driver-selectable icons. The vehicle combination meter icon 200 can also appear in conjunction with other information relevant to the driver, such as the outside temperature and the distance reading for the vehicle odometer. The vehicle interface can thus be located within the vehicle such that viewing the display is convenient for the driver, for example, while the driver is performing off-road or towing operations.

The example driver interfaces for the vehicle combination meter of FIGS. 2A-2B can use color, shading, or other types of differentiation between the road surface and sky space or external environment (not shown). Color or shading differentiation can also be used to indicate a caution condition to the driver when large angles of vehicle pitch or vehicle roll are experienced by the vehicle, as vehicle performance can change due to the vehicle being at extreme angles. As a first example of a standard condition, FIG. 2A displays a representation of vehicle pitch in vehicle status information section 202. Here, the vehicle is positioned at a 0 degree pitch measurement, driving along a flat road surface, and no variations in color or shading are indicated. The same is true in vehicle status information section 204, displaying a representation of vehicle roll, where the vehicle is positioned at a 0 degree roll measurement. The road surface in these examples is represented in one shade or color, and the sky or external environment is represented in a different shade or color simply for ease of differentiation by the driver.

As a second example of a shaded condition, FIG. 2B displays a representation of vehicle pitch in the vehicle status information section 206. Here, the vehicle is shown as positioned at a nose-down pitch angle of 30 degrees. This value or measurement is also highlighted using a color or shading indication along the angle measurement meter in order to denote caution to the driver. Caution is warranted when driving at such a steep inclination, especially during off-road operation of the vehicle. FIG. 2B also displays a representation of vehicle roll in the vehicle status information section 208, where the vehicle is shown as positioned at a right-tilted roll angle of 30 degrees. Again, this example value or measurement is highlighted or shaded to denote caution to the driver. Though vehicle pitch measurements and vehicle roll measurements are given as examples of vehicle status information associated with a first vehicle system, e.g. the inclination measurement system 116 described in FIG. 1, other vehicle systems, such as those described below, could alternatively be associated with initial selection of the vehicle combination meter icon 200 by the driver.

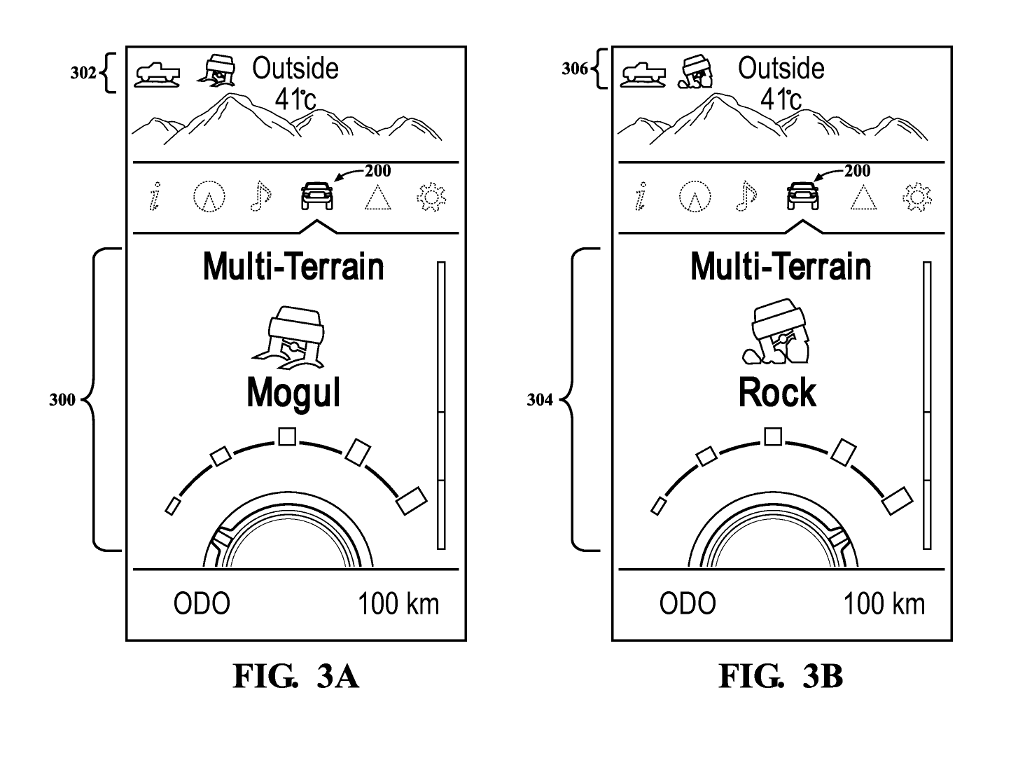

FIGS. 3A-3B are example driver interfaces for the vehicle combination meter displaying vehicle status information associated with a second vehicle system as implemented using the computing device 100 of FIG. 1. The second vehicle system represented within the example driver interfaces of FIGS. 3A-3B is the traction control system 117 mentioned in association with FIG. 1. Vehicle status information associated with the traction control system 117, for example, a terrain setting, can be displayed to the driver once the computing device 100 receives an indication that the driver has requested navigation within the driver interface to additional vehicle status information. The navigation request can be made in many ways, for example, using a button on the steering wheel, a swipe on the screen displaying the driver interface, a voice command, or any other means of indicating a desire to navigate to additional vehicle status information within the vehicle combination meter.

In the examples shown in FIGS. 3A-3B, different terrain settings associated with a multi-terrain system are displayed to the driver. A multi-terrain selection feature, for example, provided within the driver interface or as a separate switch within the vehicle, allows the driver to change the settings within the multi-terrain system in order to optimize the traction control system 117 to match the present road conditions. The multi-terrain selection made by the driver can include terrain choices such as “rock terrain,” “rock and dirt terrain,” “mogul terrain,” “loose rock terrain,” and “mud and sand terrain.” Each of these settings is useful in association with off-road operation of the vehicle. One example change made to the traction control system 117 during off-road operation can be the use of hydraulic pressure controls to implement traction changes depending on the mode selected for the multi-terrain system and the control of wheel spin and wheel lockup to provide optimized performance depending on the type of terrain the driver is traversing in the vehicle.

FIG. 3A displays a representation of a “mogul terrain” multi-terrain selection in vehicle status information section 300, where the vehicle is shown driving over a pair of small hills of different heights, i.e. moguls. The driver's use of the multi-terrain system for off-road vehicle operation is also represented in vehicle status information section 302, where a small side view of a truck on a bumpy path indicates that the multi-terrain system is currently active on the vehicle and the small icon of the vehicle driving over a pair of small hills of different heights indicates that the “mogul terrain” multi-terrain selection has been made by the driver of the vehicle. The vehicle status information section 302 can also be designed to be visible within the driver interface even when the driver navigates to another type of vehicle status information associated with the vehicle combination meter icon 200.

FIG. 3B displays a representation of a “rock terrain” multi-terrain selection in vehicle status information section 306, where the vehicle is shown as driving over a set of differently sized rocks. Again, the use of the multi-terrain system can be represented in the vehicle status information section 306, where a small side view of a truck indicates that the multi-terrain system is currently active on the vehicle and the small icon of the vehicle driving over a set of differently sized rocks indicates that the “rock terrain” multi-terrain selection has been made by the driver of the vehicle. Though not shown, different images or icons can be used to represent the rest of the available mode selections in the multi-terrain system that affect the settings of the traction control system 117 or other relevant systems. In addition, the vehicle status information sections 300, 304 in FIGS. 3A-3B can include a representation of a dial configured to be turned to the various mode selections indicated using hash marks.

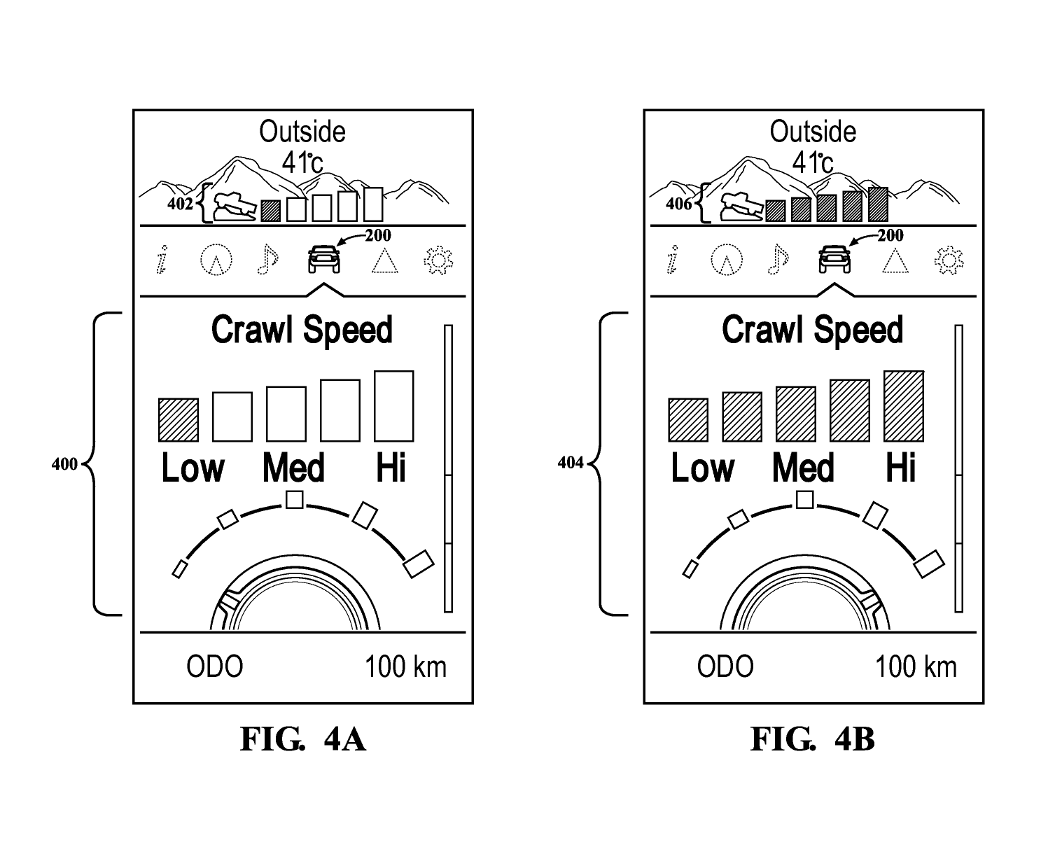

FIGS. 4A-4B are example driver interfaces for the vehicle combination meter displaying vehicle status information associated with a third vehicle system as implemented using the computing device 100 of FIG. 1. The third vehicle system represented within the example driver interfaces of FIGS. 4A-4B is the acceleration and braking system 118 mentioned in association with FIG. 1. In some embodiments, vehicle status information associated with the acceleration and braking system 118, for example, a crawl-speed setting, can be displayed to the driver once the computing device receives the first indication that the driver has requested navigation within the driver interface to additional vehicle status information. That is, the vehicle status information associated with the acceleration and braking system 118 can be the second type of vehicle status information represented within the driver interface.

In another embodiment, the driver interface can display vehicle status information associated with either the acceleration and braking system 118 or the traction control system 117, but not both, as the vehicle can be configured to allow the driver to choose to enable either one of the crawl-speed settings or one of the multi-terrain settings, but will not allow activation of these features at the same time. It should be understood that navigation between the various types of vehicle status information can be in any order, that is, any of the vehicle systems 115 described in these examples can be displayed in any navigation order, dependent only on the configuration of the vehicle combination meter and the various vehicle systems 115.

In the examples shown in FIGS. 4A-4B, different crawl-speed settings associated with the acceleration and braking system 118 are displayed to the driver. A crawl-speed selection feature, for example, provided within the driver interface or as a separate switch within the vehicle, allows the driver to maintain the vehicle at one of a few predetermined, uniform speeds in order to focus on steering the vehicle. The crawl-speed selection can include various crawl-speed settings, for example, “low,” “low-medium,” “medium,” “medium-high,” or “high.” Changes to the control signals sent to the acceleration and braking system 118 can be associated with each of the various crawl-speed settings for the crawl-speed selection feature. The driver can thus choose the proper crawl-speed setting in order to minimize wheel spin given the terrain type the vehicle is traversing, for example, while operating off road or while towing a trailer.

FIG. 4A displays a representation of a “low” crawl-speed setting in vehicle status information section 400, where the representation of a dial configured to be turned to the various crawl-speed settings is indicated using hash marks and the crawl-speed setting chosen by the driver is also displayed using a grouping of five columns, with only the first column shaded or filled. The use of the crawl-speed selection for the acceleration and braking system 118 for off-road or towing vehicle operation is also represented in vehicle status information section 402, where a small side view of a vehicle traveling up a hill indicates that some type of crawl-speed selection is currently active for the vehicle and the singular shaded or filled column among the grouping of five columns indicates that the crawl speed selection is “low.” The vehicle status information section 402 can also be designed to be visible within the driver interface even when the driver navigates to another type of vehicle status information associated with the vehicle combination meter icon 200.

FIG. 4B displays a representation of a “high” crawl-speed setting in vehicle status information section 404, where again the representation of a dial configured to be turned to the various crawl-speed settings is indicated using hash marks and the crawl-speed setting chosen by the driver is also displayed using a grouping of five columns, with all five columns shaded or filled. The crawl-speed selection for the acceleration and braking system 118 is also represented in vehicle status information section 406, where the small side view of the vehicle traveling up the hill indicates that some type of crawl-speed selection has been made by the driver and the five filled columns indicate that the crawl speed selection is “high.” Though not shown, other hash-mark and column-filled configurations can be logically associated with the “low-medium,” “medium,” and “medium-high” crawl-speed selections.

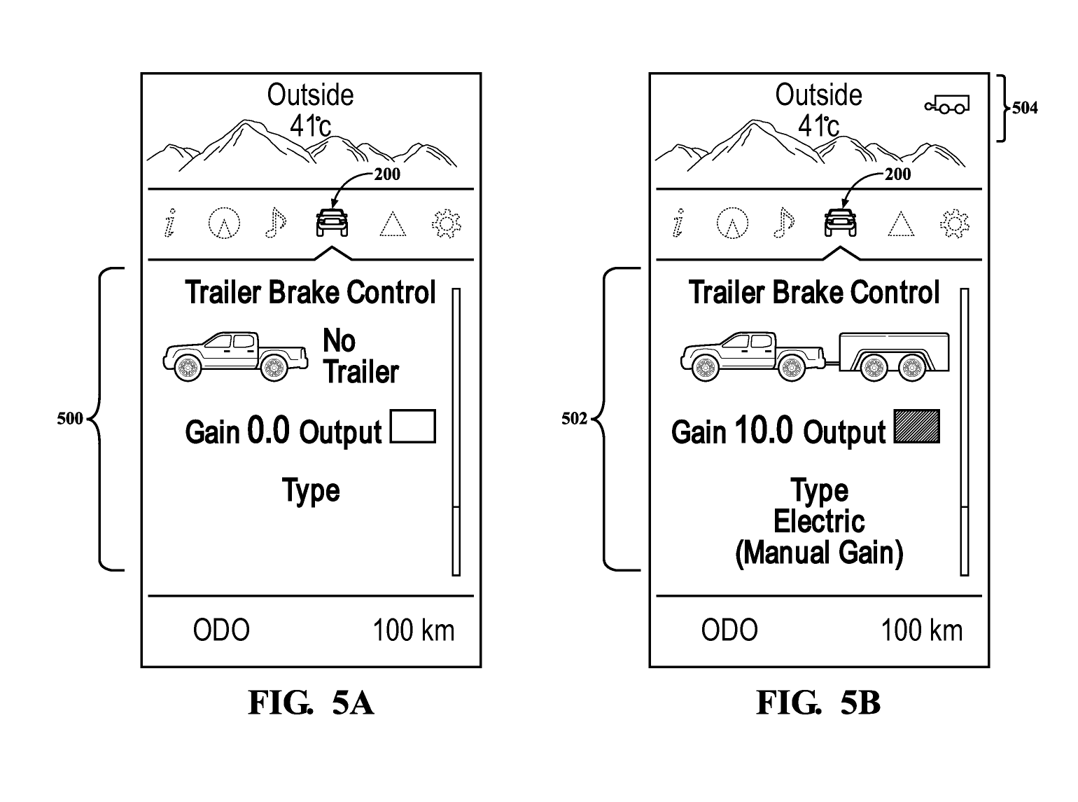

FIGS. 5A-5B are example driver interfaces for the vehicle combination meter displaying vehicle status information associated with a fourth vehicle system as implemented using the computing device 100 of FIG. 1. The fourth vehicle system represented within the example driver interfaces of FIGS. 5A-5B is the trailer brake control system 119 mentioned in association with FIG. 1. Vehicle status information associated with the trailer brake control system 119 can include the presence or absence of a trailer, the trailer brake gain level, and/or the trailer brake gain type. Various representations of this vehicle status information can be displayed to the driver once the computing device 100 receives a third indication that the driver has requested navigation within the driver interface to additional vehicle status information.

In the examples shown in FIGS. 5A-5B, the values for different settings associated with the trailer brake control system 119 are displayed to the driver. For example, the type of trailer can be displayed. Various types of trailers can include “electric-over-hydraulic (automatic gain),” “electric (manual gain),” or a blank value indicating that no trailer is currently present. In another example, the trailer brake gain value can be displayed to the driver. Some trailer brake control systems 119 can allow the driver to adjust the trailer brake gain to lessen the chances of wheel lock-up, for example, by increasing the gain for heavier trailers. In another example, the presence of a trailer can be displayed using an icon to indicate a trailer either behind a vehicle or on its own.

FIG. 5A displays a representation of the vehicle operating without a trailer in vehicle status information section 500, where the icon for the side of a truck is shown next to the words “no trailer,” the trailer brake type section is blank, and the trailer brake gain value is displayed as “0.0.” FIG. 5B displays a representation of the vehicle operating with a trailer in vehicle status information section 502, where an icon for a trailer is shown behind the icon for the side of the vehicle, the trailer type section lists “electric (manual gain),” and the trailer brake gain value is displayed as “10.0.” The presence of a trailer as associated with the trailer brake control system 119 is also represented in vehicle status information section 504, where a small side view of a trailer indicates that some type of trailer is currently attached to the vehicle. The vehicle status information section 504 can also be designed to be visible within the driver interface even when the driver navigates to another type of vehicle status information associated with the vehicle combination meter icon 200.

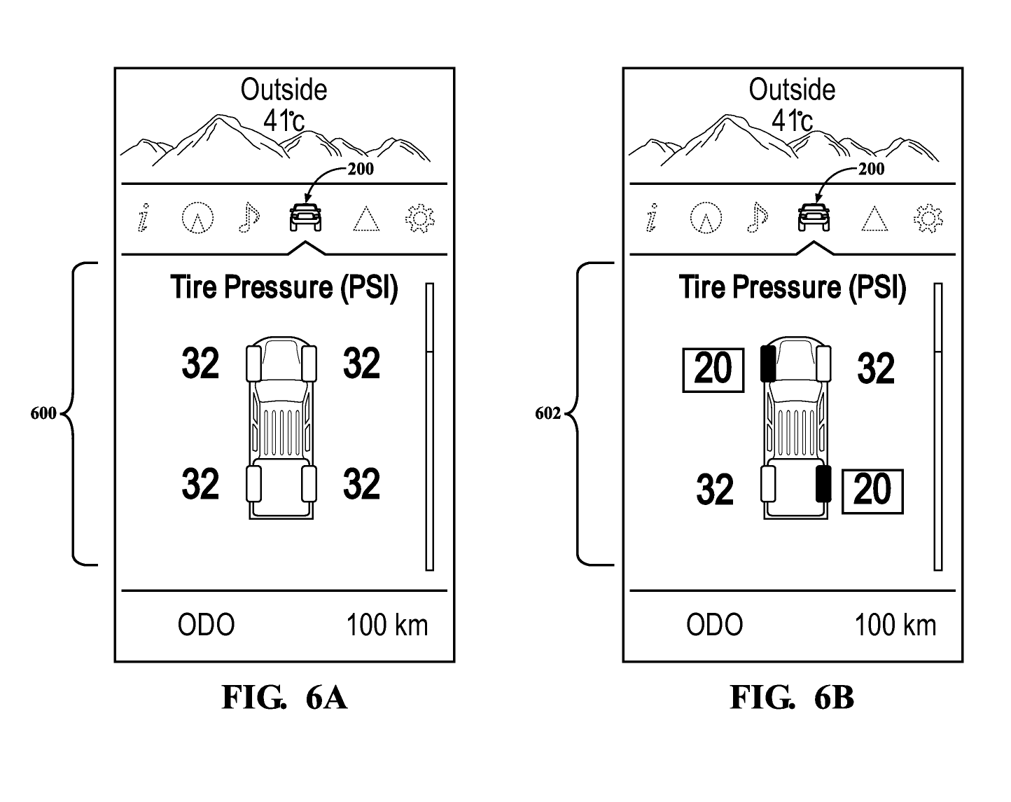

FIGS. 6A-6B are example driver interfaces for the vehicle combination meter displaying vehicle status information associated with a fifth vehicle system as implemented using the computing device of FIG. 1. The fifth vehicle system represented within the example driver interfaces of FIGS. 6A-6B is the tire pressure monitoring system 121 mentioned in association with FIG. 1. Vehicle status information associated with the tire pressure monitoring system 121 can include the tire pressure level for each of the tires on the vehicle and a low tire pressure alert meant to indicate when one of the tires has a pressure level below or above the recommended value. Various representations of this vehicle status information can be displayed to the driver once the computing device 100 receives a fourth indication that the driver has requested navigation within the driver interface to additional vehicle status information.

FIG. 6A displays a representation of the tire pressure for each tire within vehicle status information section 600, where the larger icon for the vehicle includes four smaller icons for the tires, each tire icon shaded or colored to indicate normal tire pressure, in this example, also marked by giving the value of 32 psi per tire. FIG. 6B also displays a representation of the tire pressure for each tire within vehicle status information section 602. In this example, two of the four smaller icons for the tires have a different shade meant to represent an alert condition for low tire pressure at that location. Also, the displayed value for the tire pressure, 20 psi, for each of the tires experiencing lower pressure than the recommended value are shaded or highlighted to alert the driver to a low pressure condition.

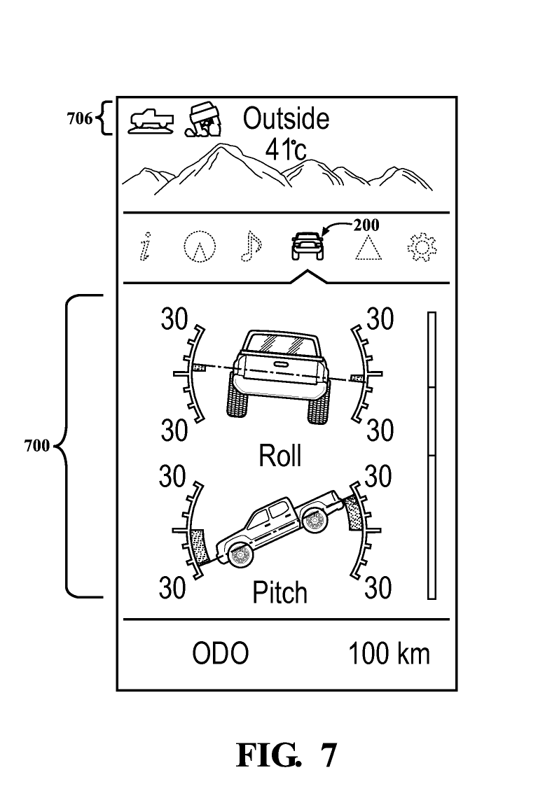

FIG. 7 is an example driver interface for the vehicle combination meter displaying vehicle status information associated with the first vehicle system and the second vehicle system as implemented using the computing device 100 of FIG. 1. Allowing the driver to monitor various types of vehicle status information associated with off-road and towing operations of the vehicle at the same time can allow for overall safer operation of the vehicle.

For example, the driver can be shown that the vehicle is currently operating with a value of “rocks” for the multi-terrain setting consistent with the vehicle status information section 306 previously described in respect to FIG. 3 at the same time that the driver has navigated to vehicle status information associated with the inclination measurement system 116 as shown in vehicle status information section 700. The vehicle status information section 700 represents that the vehicle has a right-roll angle value of approximately 5 degrees and a nose-down pitch angle value of approximately 25 degrees. In this example, the first vehicle system with representative status information is the inclination measurement system 116 and the second vehicle system with representative status information is the traction control system 117. Combined displays including multiple types of vehicle status information covering multiple vehicle systems 115 can be useful to the driver while the vehicle traverses a difficult patch of terrain or tows different types of trailers.

In another example, not shown, the driver interface for the vehicle combination meter can display vehicle status information indicating that the vehicle is operating with a value of “high” for the crawl speed at the same time that the driver has navigated to vehicle status information associated with the inclination measurement system 116. In another example, not shown, the driver interface for the vehicle combination meter can display vehicle status information indicating that the vehicle is operating with a value of “moguls” for the multi-terrain setting as would be appropriate when traveling over uphill moguls. Many different combinations of vehicle status information to be displayed to the driver at the same time are possible.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims. For example, in the embodiments described above, the vehicle is generally described an automobile. However, the vehicle is not limited to an automobile, as the driver interface can also be implemented with other vehicles that are generally controlled by a driver, or operator, such as boats, construction vehicles, etc. The scope of the claims is thus to be accorded the broadest interpretation so as to encompass all such modifications and equivalent structures.

What is claimed is:

1. A computer-implemented method of displaying a driver interface for a vehicle combination meter, comprising:
receiving, from a driver, an indication of an icon selection, the icon representing the vehicle combination meter;
sending, for display in the driver interface and in response to the indication selecting the icon for the vehicle combination meter, vehicle status information associated with a first vehicle system, the first vehicle system associated with off-road operation of a vehicle;
receiving, from the driver, an indication requesting navigation within the driver interface to additional vehicle status information; and
sending, for display in the driver interface and in response to the indication requesting navigation within the driver interface, vehicle status information associated with a second vehicle system, the second vehicle system associated with off-road operation of the vehicle.

2. The method of claim 1, wherein the first vehicle system is an inclination measurement system and the vehicle status information associated with the first vehicle system includes vehicle pitch and vehicle roll measurements.

3. The method of claim 1, wherein the second vehicle system is a traction control system and the vehicle status information associated with the second vehicle system includes a terrain setting for the traction control system.

4. The method of claim 1, wherein the second vehicle system is an acceleration and braking system and the vehicle status information associated with the second vehicle system includes a crawl speed setting for the acceleration and braking system.

5. The method of claim 1, wherein the indication requesting navigation within the driver interface is a first indication, further comprising:
receiving, from the driver, a second indication requesting navigation within the driver interface to additional vehicle status information; and
sending, for display in the driver interface and in response to the second indication requesting navigation within the driver interface, vehicle status information associated with a third vehicle system, the third vehicle system associated with at least one of off-road operation of the vehicle and towing operation of the vehicle.

6. The method of claim 5, wherein the third vehicle system is a trailer brake control system and the vehicle status information associated with the third vehicle system includes at least one of trailer presence and trailer gain level and trailer gain type.

7. The method of claim 5, further comprising:
receiving, from the driver, a third indication requesting navigation within the driver interface to additional vehicle status information; and
sending, for display in the driver interface and in response to the third indication requesting navigation within the driver interface, vehicle status information associated with a fourth vehicle system, the fourth vehicle system associated with at least one of off-road operation and towing operation of the vehicle.

8. The method of claim 7, wherein the fourth vehicle system is a tire pressure monitoring system and the vehicle status information associated with the fourth vehicle system includes at least one of a tire pressure level and a low-tire pressure alert.

9. The method of claim 1, wherein the icon representing the vehicle combination meter is displayed within a vehicle interface proximate to a plurality of driver-selectable icons.

10. A computing device, comprising:
one or more processors for controlling the operations of the computing device; and
a memory for storing data and program instructions used by the one or more processors, wherein the one or more processors are configured to execute instructions stored in the memory to:
receive, from a driver, an indication of an icon selection, the icon representing a vehicle combination meter;
send, for display in a driver interface and in response to the indication selecting the icon for the vehicle combination meter, vehicle status information associated with a first vehicle system, the first vehicle system associated with off-road operation of a vehicle;
receive, from the driver, an indication requesting navigation within the driver interface to additional vehicle status information; and
send, for display in the driver interface and in response to the indication requesting navigation within the driver interface, vehicle status information associated with a second vehicle system, the second vehicle system associated with off-road operation of the vehicle.

11. The computing device of claim 10, wherein the first vehicle system is an inclination measurement system and the vehicle status information associated with the first vehicle system includes vehicle pitch and vehicle roll measurements.

12. The computing device of claim 10, wherein the second vehicle system is a traction control system and the vehicle status information associated with the second vehicle system includes a terrain setting for the traction control system.

13. The computing device of claim 10, wherein the second vehicle system is an acceleration and braking system and the vehicle status information associated with the second vehicle system includes a crawl speed setting for the acceleration and braking system.

14. The computing device of claim 10, wherein the indication requesting navigation within the driver interface is a first indication and the processors are further configured to:
receive, from the driver, a second indication requesting navigation within the driver interface to additional vehicle status information; and
send, for display in the driver interface and in response to the second indication requesting navigation within the driver interface, vehicle status information associated with a third vehicle system, the third vehicle system associated with at least one of off-road operation of the vehicle and towing operation of the vehicle.

15. The computing device of claim 14, wherein the third vehicle system is a trailer brake control system and the vehicle status information associated with the third vehicle system includes at least one of trailer presence and trailer gain level and trailer gain type.

16. The computing device of claim 14, wherein the processors are further configured to:
receive, from the driver, a third indication requesting navigation within the driver interface to additional vehicle status information; and
send, for display in the driver interface and in response to the third indication requesting navigation within the driver interface, vehicle status information associated with a fourth vehicle system, the fourth vehicle system associated with at least one of off-road operation and towing operation of the vehicle.

17. The computing device of claim 16, wherein the fourth vehicle system is a tire pressure monitoring system and the vehicle status information associated with the fourth vehicle system includes at least one of a tire pressure level and a low-tire pressure alert.

18. The computing device of claim 10, wherein the icon representing the vehicle combination meter is displayed within a vehicle interface proximate to a plurality of driver-selectable icons.
